(19) United States
(12) Patent Application Publication
(10) Pub. No.: US 2006/0007820 A1
(43) Pub. Date: Jan. 12, 2006

(54) Digital audio recorder for CD collections

(76) Inventors: Richard Adams, New York, NY (US); Jeffrey L. Grayson, New York, NY (US); Russell Dubner, New York, NY (US)

Correspondence Address: NIELDS & LEMACK, 176 EAST MAIN STREET, SUITE 7, WESTBORO, MA, 01581, US

(21) Appl. No.: 11/142,541

(22) Filed: Jun. 1, 2005

Related U.S. Application Data
(60) Provisional application No. 60/576,104, filed on Jun. 2, 2004.

(51) Int. Cl. G11B 5/09

(52) U.S. Cl. 369/47.12; 369/84

(57) ABSTRACT

The present invention provides a high-speed digital audio recorder, capable of converting collections of CDs quickly to digital audio formats, such as MP3, AAC, WAV, WMV, and others. This recorder consists of a plurality of computing units each equipped with specialized software, tailored specifically to the conversion process. In addition, the system offers the ability to inject identifiers, such as ID3 tags, watermarks, or digital rights into each track, thereby offering a powerful deterrent to the unlawful sharing of these digital files with others.

This application claims priority of U.S. Provisional application Ser. No. 60/576,104 filed Jun. 2, 2004, the disclosure of which is incorporated herein by reference.

### BACKGROUND OF THE INVENTION

For many years, people have used different mechanisms to replicate their copyrighted works. One of the first of these mechanisms was the cassette recorder, which allowed users to replicate their vinyl albums onto cassette tapes. This machine allows the user to listen to his copyright protected album in environments that were incapable of playing albums in their native media and format, such as automobiles or portable stereos. Subsequently, video cassette recorders (VCRs) allowed users to replicate copyright protected shows from television onto video cassette tape and replay them at a later, more convenient time.

For many years, it was unclear whether these acts by consumers constituted copyright infringement. In 1992, the American Home Recording Act (AHRA) was enacted. This statute stated that “no action may be brought under this title alleging infringement of copyright based on the manufacture, importation, or distribution of a digital audio recording device, a digital audio recording medium, an analog recording device, or an analog recording medium, or based on the noncommercial use by a consumer of such a device or medium for making digital musical recordings or analog musical recordings.” Since the enactment of the AHRA, consumers are free to copy their copyright protected works for their own personal use. Examples of these authorized uses include copying CDs to cassette tapes; copying TV shows to video tape; storing television shows in digital format for future viewing; converting CDs to alternative formats for use with computers, Apple IPODs™ or MP3 players. However, the AHRA only allows the recording of copyright protected works for personal usage. Therefore, music-swapping services that appeared on the internet, such as Napster and Kazaa, were not protected under the AHRA, since these usages were no longer considered personal. Instead, these services allowed users who had not purchased the copyright protected work to gain free access to it by downloading it from a website.

Because of the AHRA, consumers are able to legally copy their entire CD collection onto their computer. From there, they can either play these collections on their computer, or convert them to an alternate format, such as MP3, and download them into a portable device, such as an MP3 player or Apple IPOD™. Many companies are currently offering software that enables the consumer to convert their CDs to other formats. However, the process of copying a CD onto a computer and converting it to another format, known as “ripping”, can be a long and tedious process. Each CD must be inserted into the CD drive of the computer; the contents must then be copied onto the storage device of the computer, typically a disk drive, and a software program must then convert the data from the CD into an alternative format. This process can take more than fifteen minutes per CD, so a user with an extensive collection of hundreds of CDs may never find enough time to copy their entire CD collection.

In addition, most of these programs simply convert the tracks of the CD from its native format to another, without identifying the owner of the files. Once in digital format, it becomes very easy for users to “share” their converted CDs with their friends and colleagues, in violation of copyright laws.

Therefore, it is an object of this invention to provide a high speed digital audio recorder, capable of converting hundreds of CDs into digital format quickly. It is a further object of this invention to perform this function while offering several deterrents to sharing, thus preserving the integrity of the original copyright protected work.

### SUMMARY OF THE INVENTION

The problems of the prior art have been overcome by the present invention, which provides a high speed digital audio recorder, capable of converting collections of CDs quickly into copyright protected digital audio files, encoded in formats such as MP3, AAC, WAV, WMV, and others. The digital audio files output by the recorder are named and tagged with rich meta-information, such as artist, album, genre, and other data. This recorder consists of a plurality of computing units each equipped with specialized software, tailored specifically to the conversion process. In addition, the system offers the ability to inject identifiers, such as ID3 tags, watermarks, or digital rights into each track, thereby offering a powerful deterrent to the unlawful sharing of these digital files with others.

### BRIEF DESCRIPTION OF THE DRAWINGS

FIG. 1 is a schematic diagram illustrating the process flow of a first embodiment of the Digital Audio Recorder in accordance with the present invention;

FIG. 1a is a schematic diagram illustrating the process flow of a second embodiment of the Digital Audio Recorder in accordance with the present invention;

FIG. 2 is a schematic diagram illustrating the Extract process in accordance with the present invention;

FIG. 3 is a schematic diagram illustrating a first embodiment of the Watermark process in accordance with the present invention;

FIG. 3a is a schematic diagram illustrating a second embodiment of the Watermark process in accordance with the present invention;

FIG. 4 is a schematic diagram illustrating a first embodiment of the Encode process in accordance with the present invention;

FIG. 4a is a schematic diagram illustrating a second embodiment of the Encode process in accordance with the present invention;

FIG. 5 is a schematic diagram illustrating the Lookup process in accordance with the present invention;

FIG. 6 is a schematic diagram illustrating the Tag&Rename process in accordance with the present invention; and

FIG. 7 is a schematic diagram illustrating the Burn&Load process in accordance with the present invention.

### DETAILED DESCRIPTION OF THE INVENTION

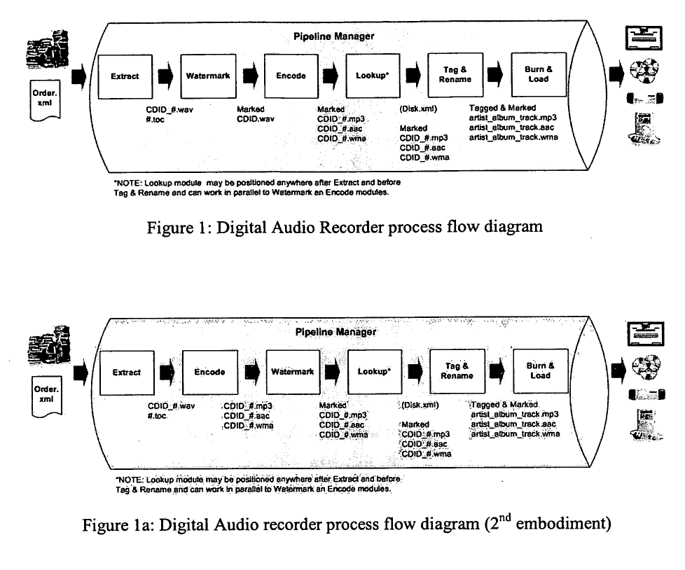

FIG. 1 is a schematic diagram of the process flow involved in the preferred embodiment of the present invention. Variations of this flow are possible without deviating from the spirit of the invention. One such variation, which will be described later, is illustrated in FIG. 1a. At a macroscopic level, the preferred embodiment of the invention circuit has a collection of CDs as its input, and produces a set of copyright protected digital files, corresponding to the tracks of these CDs, as its output.

The preferred process flow comprises six discrete steps. The process manager is a software process, which oversees the interaction and flow of these six software processes. Each of these six software processes implements a defined pipeline interface which permits each process to maximize computational resources while communicating with adjacent processes in the pipeline. Each process implementing this interface actively monitors a specific input directory for files being output by the preceding process and, in turn, writes its processed files to an output directory which is the input directory of the following process. The resulting modularized structure enables these processes to be separated, such that one or more of them can be executed on a different computing element or set of computing elements. In the preferred embodiment, each of the enumerated software processes is executed on a dedicated set of computing elements, such that the throughput of the entire system can be maximized. In this way, the computing resources assigned to each process can be optimized such that the throughput of the overall system is maximized without adding unnecessary and unused computing capacity. In the preferred embodiment, the software processes communicate through output directories. Specifically, the output from one process is placed in a predetermined output directory, which a subsequent process uses as its input directory. However, those skilled in the art will appreciate that one or more of these processes can be executed on the same computing elements without departing from the spirit of the invention. Similarly, those skilled in the art will appreciate that the processes can communicate with each other using a variety of other methods.

Before the process is begun, the system preferably is initialized with the required parameters. These parameters are preferably the requested preferences from the user. An example of one such parameter is the operating system, where the user can specify the platform that he typically uses, such as, but not limited to, Windows, Macintosh and Linux. This information may be necessary for the proper formatting of the files and of the resulting DVD.

A second example of such a parameter is the encoding preference of the user. There are a large number of encoding techniques for audio files. The Digital Audio Recorder of the present invention will encode the CDs according to the user's choice. Encoding techniques include, but are not limited to, MP3 (MPEG Level 3), AAC (Advanced Audio Coding), WMA (Windows Media Audio), OGG Vorbis, VFQ and others.

A third parameter example is the delivery mechanism. In the preferred embodiment, the user would obtain all tracks from the CD collection in the preferred digital audio format on a set of DVD disks. Optionally, the user could obtain the collection already loaded onto a hard drive for insertion into the user's computer, or onto a portable audio player, such as an MP3 player, or an Apple IPOD™.

A fourth parameter example is the copyright protection scheme to be employed. Three different mechanisms for copyright protection are used in the preferred embodiment. The first, known as ID3 tagging, adds information to either the beginning or the end of a music audio track. In this way, various ancillary information, such as the name of the song, the artist, the album, the genre, and the year of release, can be made available. The information in the ID3 tag will typically appear in a standard media player window on a computer screen. These tags can also be used to denote other information. In the preferred embodiment, the name of the user who has copied his CD to a digital audio format will be entered, thereby making it possible to track this user if he were to share it with other users, who were not entitled to the copyright protected work.

A second copyright protection mechanism is known as watermarking. This term, also used for currency, refers to a mechanism whereby a mark is placed through the object, which cannot be removed without destroying the object itself. Digital watermarking inserts bits of information into a digital file, such as a graphical image, video stream, or audio stream, which, unlike ID3 tags, are not easily detectable and cannot be removed easily without knowledge of the encryption technique. There are a number of commercially available digital watermark applications that enable an audio file to be watermarked in such a way that the modifications are unperceivable to the human ear. This watermark mechanism provides a stronger deterrent to copyright infringement in that the user cannot simply delete a portion of the file, as he can with ID3 tagging, to remove any references to his identity.

A hybrid variation of ID3 tagging and watermarking is also possible. In this embodiment, a unique identifier field is placed within the file, much like is done during ID3 tagging. However, instead of placing the identifier in a known location, such as the beginning or the end of the file, as is done with ID3 tagging, it is placed at a random location within the file. This random placement makes it more difficult for a malicious user to manually remove the identifier, since its location is less predictable, thus making it an improvement over traditional ID3 tagging. Therefore, this variation offers a level of protection that approaches that of watermarking, while having the simplicity of ID3 tagging.

A third copyright protection mechanism is known as Digital Rights Management (DRM). This mechanism provides the most powerful copyright protection and enables user “rights” to be associated with a particular file. For example, a file can be marked in such a way that only the original user can play that file on his computer or personal player. As with watermarking, various implementations of DRM exist, with the most popular versions currently being commercially available from Apple and Microsoft.

Other parameters include the user's preference concerning the extended information, such as album art, lyrics, and other similar information, which can be included in the ID3 tagging for each track. Still other parameters, such as the user's desired directory structure for the DVDs, are within the scope of the present invention. This list of user parameters is meant to be representative of the capabilities of the present invention and is not an exhaustive list of all possible user parameters.

The user parameters can be input into the Digital Audio Recorder of the present invention through a number of methods, such as manual entry.

The preferred method involves the user, at a location remote from the Digital Audio Recorder, requesting a set of options on a web page asking for his preferences. These parameters are then submitted via the internet to the Digital Audio Recorder of the present invention, along with a user identification number when the user completes the form. In the preferred embodiment, the user authorizes the replication of his CD collection by “clicking” an icon on the web page, labeled “Record”. This action authorizes the Digital Audio Recorder, acting as an agent of the user, to replicate the CD collection. The information submitted via the internet is shown in FIGS. 1 and 1a as order.xml. This user identification number would then be used to identify the physical CD collection owned by this user. The physical CD collection is delivered from the user to the Digital Audio Recorder via ordinary means, such as mail, Federal Express or other similar means.

Once the user parameters and the CD collection have been associated with each other, the process manager can begin the conversion process. The process manager determines the number of CDs that are to be converted and also determines the current usage of the computing elements in the system. In the preferred embodiment, the process manager uses this information to divide the user's order into smaller units for processing in an attempt to better balance the computing load between the various machines. The preferred embodiment is configured and designed such that the process manager is able to divide the order across multiple processing units where each processing unit is adapted to operate on individual files. The various customer preferences contained in order.xml are also loaded into the system, as this information will be used at various points in the process. Representative pseudo-code of the initialization process is shown in Appendices A and B, in the first section.

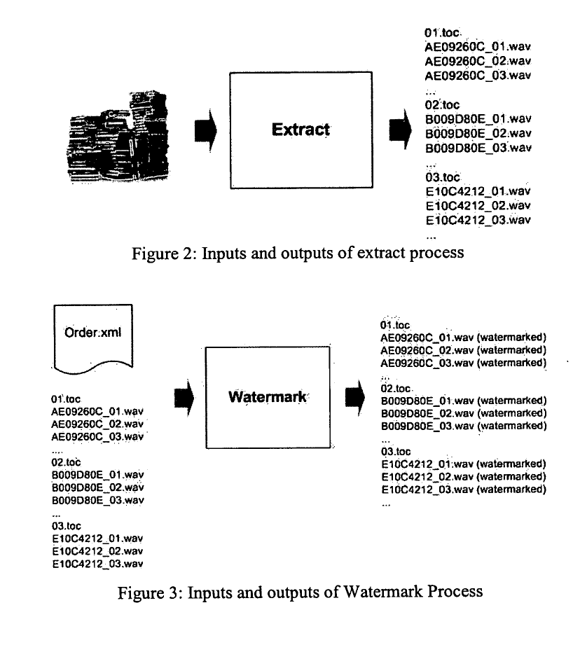

The first process in the Digital Audio Recorder is the Extract process, as shown in detail in FIG. 2. The user's CD collection is bulk loaded, preferably into an environment in which the CDs can be loaded and removed via automation. In the preferred embodiment a bank of multiple CD drives is utilized, in conjunction with a robotic mechanism, such as a robotic arm, capable of removing the CDs when their contents have been copied and loading other CDs into the drive. Alternatively, a plurality of CD auto-changers can be utilized to allow a similar throughput with limited human intervention. As each CD is loaded, its contents are copied into an output directory. Digital audio extraction (DAE) software is used to extract the contents of the CD, which is typically encoded as CDDA (CD Digital Audio). This software, which is well known in the art, first extracts a Table of Contents file, which contains a .toc suffix. This file is then preferably written to an output directory, using a sequential integer value as the file name, followed by the .toc suffix. FIG. 2 shows the preferred format of the table of contents files that are copied. While names such as 01.toc, 02.toc, etc. are used in this example, the files could assume any name without departing from the spirit of the invention. After the table of contents file has been copied to an output directory, the individual tracks on the CD are then read, converted and written to the output directory as .wav files, which is the native format for audio files. As shown in FIG. 2, the nomenclature for the file names of the individual tracks consists of a string, followed by an underscore, followed finally by the track number. In the preferred embodiment, the string used in the file name is the unique digital identifier assigned to that CD, which is used later in the process to uncover more comprehensive information about the CD, such as track names, artist name and album name via a lookup service. This unique digital identifier, known as the CDID, can also be used as the filename of the table of contents file. After the last track of the CD has been copied to the output directory, the automated CD changing system removes the CD and, if there are other CDs remaining, loads a different CD into the reader. Optionally, a distinguishing mark can be placed on the CD at this point, such as by indelible marker or laser, which signifies that the current CD has been processed. If it is discovered that a CD being input into the Extract process already has this distinguishing mark, the CD will be rejected so as to protect against the unlawful replication of the CD. After the CD is removed, the process repeats until all of the CDs in the collection have been copied to the output directory. Representative pseudo-code for the Extract process is shown in the second section of Appendices A and B.

In the preferred embodiment, the process manager allows the various processes to operate concurrently. For example, in the embodiment shown in FIG. 1, the Watermark process is initialized and begins execution before the Extract process has completed copying all of the CDs to the output directory. In this manner, the operations are pipelined, thereby minimizing the total duration of the Digital Audio Recorder processing.

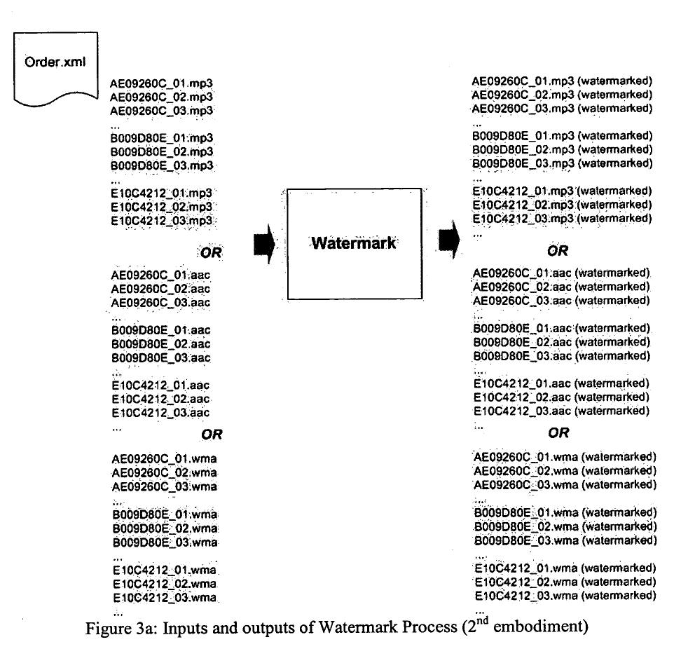

As shown in FIG. 3, the Watermark process utilizes information contained in the order.xml file, which the user supplied earlier. In the preferred embodiment, the Watermark process obtains information concerning the type of copyright protection that the user desires. Additionally, the preferred embodiment uses the customer order number to create the watermark that will be embedded in all of the files. This allows the original owner of the files to be determined by decoding the watermark, using special keys and software.

As shown in FIG. 3, in one embodiment, the Watermark process also uses the output directory created by the Extract process as its input directory. In the preferred embodiment, the Watermark process is executed on a multiprocessor system, such that it can operate on many files simultaneously. The physical implementation of the multiprocessor system can vary. One embodiment includes a farm having multiple slaves, whereby a single master supplies each with additional tasks based on resource utilization. A second embodiment consists of a single multiprocessor system, with a multi-processor aware operating system, such that the operating system and the Watermark software automatically load share the execution of the routine across the various processors. Other embodiments of multiprocessor systems are well known in the art and are within the scope of the invention.

The Watermark process continuously monitors the output directory from the Extract process. When it detects that a new .wav file has been added to the directory, it checks the status of the various processors and dispatches the file to one of the processors, preferably the one with the lightest processing load. Once dispatched, the main loop of the Watermark process continues the monitor for additional .wav files.

While the main loop continues to monitor the output directory of the Extract process, each slave processor is executing the more algorithmically challenging watermarking procedure. Digital watermarking technology is well known in the art and the Watermark process is able to make use of any of the commercially available software programs for this function. Alternatively, proprietary watermarking software can be employed at this step. In the preferred embodiment, the processors use the customer order number, found in the order.xml file, to generate the specific watermark code that is to be used. The .wav file is then modified to incorporate the watermark and is then written to an output directory, preferably different from that used by the Extract process, as shown in FIG. 3. The watermark is preferably perceptually coded, such that it is inaudible to the human ear. The process continues until all tracks from the user's CD collection have been watermarked. Through use of the customer order number, it is possible to monitor the subsequent distribution of the digital file, since the watermark cannot be removed. For example, software is available that can decipher the embedded watermark, thereby revealing the original customer order number. In this way, illegal copies of an audio file can be traced back to their original source, thus providing a powerful deterrent to illegal copying. Representative pseudo-code for this embodiment of the Watermark process is shown in the third section of Appendix A.

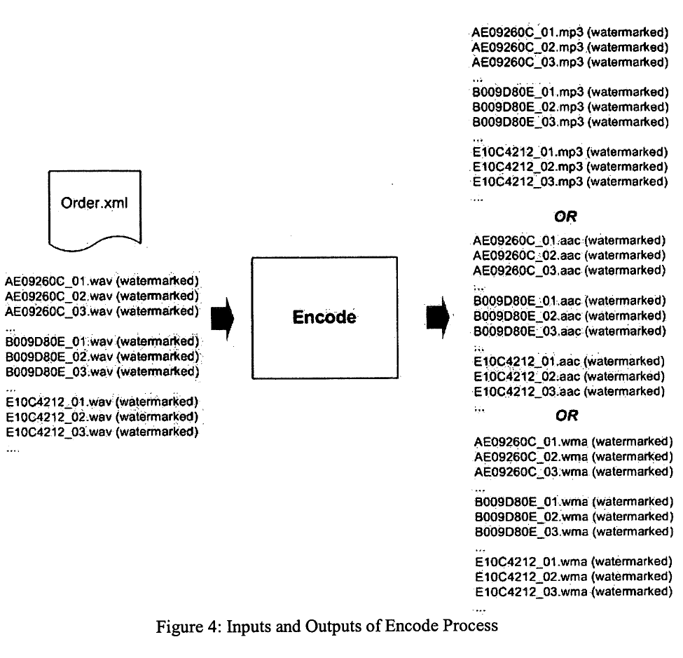

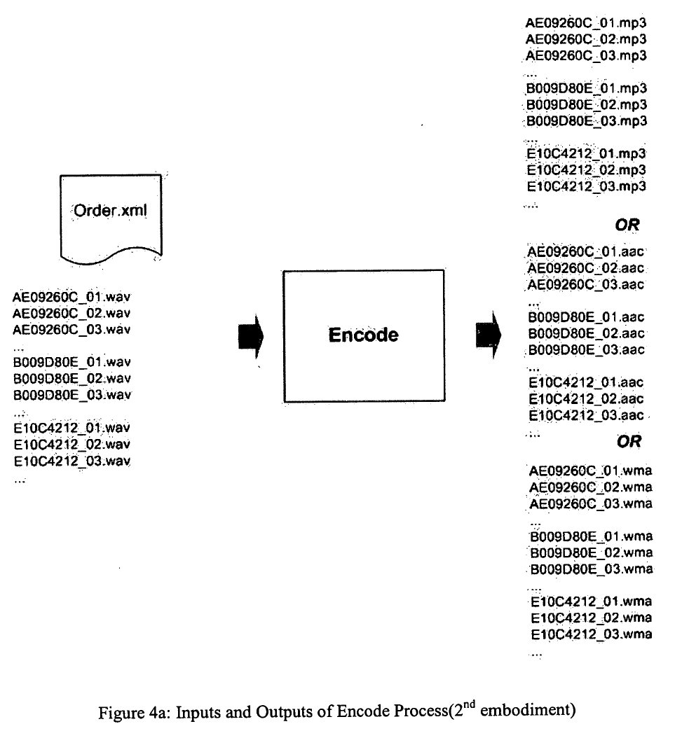

As shown in FIG. 4, the Encode process utilizes information contained in the order.xml file, which the user supplied earlier. In the preferred embodiment, the Encode process obtains information concerning the encoding scheme, such as MP3, AAC, or WMA, and configuration settings, such as bit rate, that the user selected.

As shown in FIG. 1, the Encode process uses the output directory created by the Watermark process as its input directory. In the preferred embodiment, the Encode process is executed on a multiprocessor system, such that it can operate on many files simultaneously. The physical implementation of the multiprocessor system can vary. One embodiment includes a farm having multiple slaves, whereby a single master supplies each with additional tasks based on resource utilization. A second embodiment consists of a single multiprocessor system, with a multi-processor aware operating system, such that the operating system and the Watermark software automatically load share the execution of the routine across the various processors. Other embodiments of multiprocessor systems are well known in the art and are within the scope of the invention.

In this embodiment, the Encode process continuously monitors the output directory from the Watermark process. When it detects that a new watermarked .wav file has been added to the directory, it checks the status of the various processors and dispatches the file to one of the processors, preferably the one with the lightest processing load. Once dispatched, the main loop of the Encode process continues the monitor for additional watermarked .wav files.

While the main loop continues to monitor the output directory of the Watermark process, each slave processor is executing the encoding procedure. Digital encoding from .wav format to other digital audio formats is well known in the art and the Encode process is able to make use of any of the commercially available software programs for this function. Alternatively, proprietary encoding software can be employed at this step. The watermarked .wav file is then encoded based on the user's preferences and is then written to an output directory, preferably different from that used by the Watermark process, as shown in FIG. 4. FIG. 4 shows output files being encoded in one of three popular encoding techniques. The first is .mp3, which is the resulting output when the file is encoded using the technique described in the MPEG1, Audio Layer 3 specification. This technique uses perceptual coding, which is a “lossy” compression, eliminating frequencies inaudible to the human ear. MP3 offers high compression rates, and is readable by most digital audio players. The second is .aac, which is the resulting output when the file is encoded using Advanced Audio Coding, part of the MPEG4 specification. This format is an improvement over MP3, offering improvement compression and is currently used by Apple Computer™ in their online iTunes Music Store. The third format is .wma, which is the output when the file is encoded using Microsoft's Windows Media Audio. This format also allows the use of Microsoft's Digital Rights Management (DRM). DRM allows a file to be encoded with permissions, such as the ability to play or copy the file. In the preferred embodiment, DRM is used to inhibit the copying and thus the sharing of digital audio files, thereby helping to limit potential infringement of the artist's copyright. This option would be a customer preference entered into the order.xml file. While it is anticipated that these three formats would be the most popular, the invention is not limited to only these formats. Other formats, such as OGG Vorbis, VFQ, and others are currently available and new encoding techniques are being developed as computing capabilities increase. The current invention is designed to accommodate any digital audio encoding techniques, available today, or in the future. The process continues until all tracks from the user's CD collection have been encoded. Representative pseudo-code for the Encode process is shown in the fourth section of Appendix A.

A second embodiment of the Digital Audio Recorder is shown in FIG. 1a. This embodiment is similar to that illustrated in FIG. 1, except that the Encode and Watermark processes are interchanged, such that the digital files are encoded before they are watermarked.

In this second embodiment, the Encode process utilizes information contained in the order.xml file, which the user supplied earlier, as shown in FIG. 4a. In the preferred embodiment, the Encode process obtains information concerning the encoding scheme, such as MP3, AAC, or WMA, and configuration settings, such as bit rate, that the user selected.

As shown in FIGS. 1a and 4a, the Encode process also uses the output directory creating by the Extract process as its input directory. As described above, the Encode process is preferably executed on a multiprocessor system, such that it can operate on many files simultaneously. The physical implementation of the multiprocessor system can vary. One embodiment includes a farm having multiple slaves, whereby a single master supplies each with additional tasks based on resource utilization. A second embodiment consists of a single multiprocessor system, with a multi-processor aware operating system, such that the operating system and the Watermark software automatically load share the execution of the routine across the various processors. Other embodiments of multiprocessor systems are well known in the art and are within the scope of the invention.

In accordance with FIG. 1a, the Encode process continuously monitors the output directory from the Extract process. When it detects that a new .wav file has been added to the directory, it checks the status of the various processors and dispatches the file to one of the processors, preferably the one with the lightest processing load. Once dispatched, the main loop of the Encode process continues the monitor for additional .wav files.

While the main loop continues to monitor the output directory of the Extract process, each slave processor is executing the encoding procedure. As described earlier, digital encoding from .wav format to other digital audio formats is well known in the art and the Encode process is able to make use of any of the commercially available software programs for this function. Alternatively, proprietary encoding software can be employed at this step. The .wav file is then encoded based on the user's preferences and is then written to an output directory, preferably different from that used by the Extract process, as shown in FIG. 4a. FIG. 4a shows output files being encoded in one of three popular encoding techniques, as described above. While it is anticipated that these three formats would be the most popular, the invention is not limited to only these formats. Other formats, such as OGG Vorbis, VFQ, and others are currently available and new encoding techniques are being developed as computing capabilities increase. The current invention is designed to accommodate any digital audio encoding techniques, available today, or in the future. The process continues until all tracks from the user's CD collection have been encoded. Representative pseudo-code for this embodiment of the Encode process is shown in the third section of Appendix B.

In this second embodiment of the Digital Audio Recorder, shown in FIG. 1a, the Watermark process uses the output directory creating by the Encode process as its input directory. As shown in FIG. 3a, this second embodiment of the Watermark process also utilizes information contained in the order.xml file, as described earlier. As described above, the Watermark process is preferably executed on a multiprocessor system, such that it can operate on many files simultaneously.

As shown in FIGS. 1a and 3a, the Watermark process continuously monitors the output directory from the Encode process. When it detects that a new .mp3 (or .aac or .wma) file has been added to the directory, it checks the status of the various processors and dispatches the file to one of the processors, preferably the one with the lightest processing load. Once dispatched, the main loop of the Watermark process continues the monitor for additional compressed files.

While the main loop continues to monitor the output directory of the Encode process, each slave processor is executing the more algorithmically challenging watermarking procedure, as described earlier.

The compressed audio file is then modified to incorporate the watermark and is then written to an output directory, preferably different from that used by the Encode process, as shown in FIG. 3a. The watermark is preferably perceptually coded, such that it is inaudible to the human ear. The process continues until all tracks from the user's CD collection have been watermarked. Through use of the customer order number, it is possible to monitor the subsequent distribution of the digital file, since the watermark cannot be removed. For example, software is available that can decipher the embedded watermark, thereby revealing the original customer order number. In this way, illegal copies of an audio file can be traced back to their original source, thus providing a powerful deterrent to illegal copying. Representative pseudo-code for the second embodiment of the Watermark process is shown in the fourth section of Appendix B.

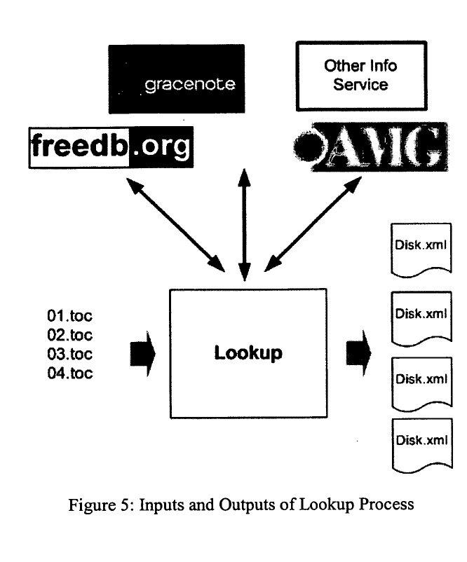

The Digital Audio Recorder also allows the insertion of information that is not found natively on the CD. For example, the files contained on the CD will indicate the starting location of each track, but there is no indication of the title of the track, the duration of the song, the artist, genre or album name. This information, while not available on the CD, is accessible, however, via a number of on-line database services, such as, but not limited to Freedb (located at www.freedb.org), AMG (located at www.allmusic.com), Muze (located at www.muze.com) and CDDB (located at www.gracenote.com). FIG. 5 illustrates the inputs and outputs used by the Lookup process. Using a standard application program interface (API), the Lookup process sends the information contained in the table of contents file to one of the on-line services. In response, that service returns basic information about the CD, including the duration of each song, the artist's name, the album name, the name of each track, and the genre. This information is delivered as an .xml file, which is shown in FIG. 5 as Disk.xml. Those skilled in the art will appreciate that the file need not be in .xml format, and that a variety of naming conventions can be used. For example, the file can be named according to the album name, the artist, or the unique CDID. Each table of contents file results in the creation of a unique file. Based on the user's preferences, which are stored in the order.xml file, the Lookup routine optionally consults these databases, or additional databases, and retrieves additional extended information, such as, but not limited to, album art, and lyrics. This process is repeated for each CD in the collection. While the toc and the CDID are often used to identify a particular CD, other methods are possible and within the scope of the present invention. For example, the waveform contained within a particular track could also be used to uniquely identify a CD.

Although FIG. 1 shows a particular sequence during which the Lookup process is executed, this process can be executed at a number of different stages during the pipelined process. The Lookup process can be executed as early as immediately after the Extract process when table of contents files are available. Alternatively, it can be executed as late as immediately before the Tag & Rename process. In addition, since it does not rely on any information produced by the Watermark and Encode processes, it can be executed in parallel with these processes, if desired. These various implementations of the pipelined process are all within the scope of the present invention. Representative pseudo-code for the Lookup process is shown in the fifth section of Appendices A and B.

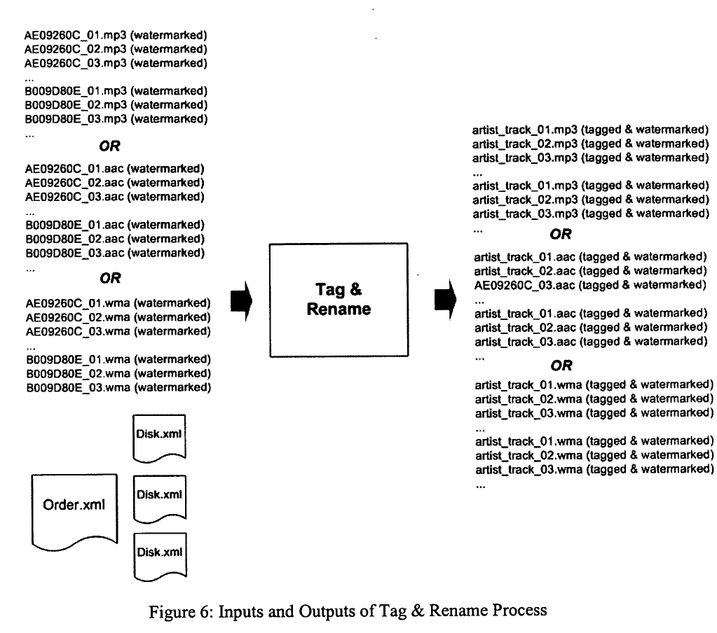

As shown in FIG. 6, the Tag&Rename process utilizes information contained in the order.xml file, which the user supplied earlier, and the disk.xml file, retrieved from the online database service. In the preferred embodiment, the Tag&Rename process obtains information concerning the user's file content preferences, such as the inclusion of album art and lyrics. Using this information, the Tag&Rename process transforms each watermarked compressed output file from the preceding process's output directory. Specifically, for the embodiment shown in FIG. 1, the output directory of the Encode process is used as the input directory to the Tag&Rename process. For the embodiment shown in FIG. 1a, the output directory of the Watermark process is used as the input directory for this process. In the preferred embodiment, the watermarked output file is associated to a specific disk.xml file by the CDID. The CDID information is available in the disk.xml file generated by the Lookup process, either as part of the name of the file, or is stored within the disk.xml file itself. The Tag & Rename process scans the available files created by the Lookup process to locate the CDID corresponding to the watermarked output file. The name of the file is changed from the string identifier used early to a more descriptive name. In the preferred embodiment, the naming convention for the files is artist name (retrieved from the disk.xml file), followed by an underscore, optionally followed by the album name(retrieved from the disk.xml file), followed by a second underscore, followed finally by the track number and the associated file extension. This format is seen in the output files of FIG. 6. Optionally, the user can select an alternative file naming scheme, such as, but not limited to, including the name of the track or other information, or eliminating the artist's name or the album name.

In addition to renaming the file, the Tag&Rename process also appends information to the beginning of the file. This process, which was described earlier, is referred to as ID3 tagging. Based on the user's preference, the process will add information such as, but not limited to, the duration of the track, the name of the track, the artist's name, the album name, CD artwork and track lyrics. Optionally, the customer order number can be included as part of the tagged information. This allows a simple method of monitoring the subsequent distribution of this digital file after it is returned to the user. However, this method offers only limited protection against illegal replication, as the tag can be deleted from the file without damaging the rest of the file. Once these operations are completed, the newly named file is written to an output directory. This process continues until each file has been properly tagged and renamed.

In some instances, the online database services may not have information concerning a particular CD, such as a particularly rare CD, or one from a foreign country. In those cases, there will not be a disk.xml file associated with the tracks of that CD. In the preferred embodiment, the Tag&Rename process detects this error, and does not insert any tag information into the file, since none is known. It then renames the file to a default name, such as that of the input file, or optionally appending the word “unknown” before the existing file name. After this renaming operation is completed, the file is moved to the output directory. Representative pseudo-code for the Tag&Rename process is shown in the sixth section of Appendices A and B.

At this point, the Digital Audio Recorder has converted all of the tracks from the entire CD collection to digital audio files, based on a set of user preferences. Depending on the number of CDs in the collection, the resulting files can be extremely large, perhaps over 10 Gbytes. Since this output is so large, a convenient mechanism is needed to deliver this information back to the user that requested it. In today's computer networks, the amount of data involved precludes the use of electronic forms of transfer, since as email, ftp or other similar delivery vehicles. While this may be more practical in the future, the preferred embodiment of the invention relies on portable storage media to deliver the information to the remote user.

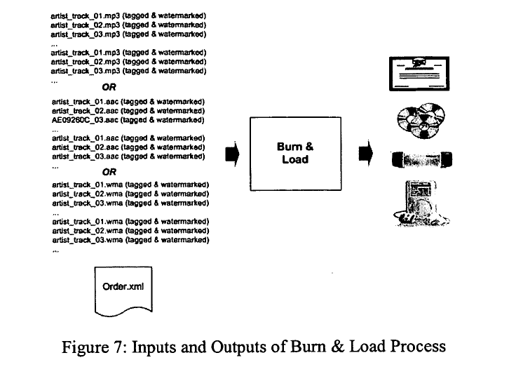

As shown in FIG. 7, the Burn&Load process utilizes information contained in the order.xml file, which the user supplied earlier, as well as the tagged and watermarked digital files produced by the Tag&Rename process. In the preferred embodiment, the contents of the output directory of the Tag&Rename process are separated into blocks, where each of these blocks is less than the capacity of a DVD disk. In the preferred embodiment, albums and tracks are not divided across multiple DVD disks. Therefore, if an entire album cannot be loaded onto the DVD disk, it will be moved in its entirety to the next disk. In one embodiment, each of these blocks is converted to ISO image format, which is the standard format for data on CDs and DVDs, although other formats are possible and within the scope of the present invention. Optionally, file names are truncated to less than 127 characters, however, they must retain the proper file extension.

In the preferred embodiment, the first image is somewhat smaller than the capacity of a DVD disk to allow a software installation program, such as, but not limited to InstallShield®, Wise for Windows, or a proprietary application, to be added to the first disk. This installation program guides the user through the loading of all of the DVDs onto his computer in a simple, easy to follow method, similar to that used by other large software programs. In an alternate embodiment, the installation software program is provided on a separate CD or DVD. In either embodiment, each individual DVD may contain a specific sequence number, corresponding to the order in which they should be installed.

The file structure of the DVDs is based on the user's preferences as described in the order.xml file. The image may contain all of the files in a flat directory structure, where all of the files are contained within the same directory. Optionally, the image can be structured such that each album represents a directory, with the various files associated with the tracks of that album existing within that directory. Other directory structures are possible, such as, but not limited to, structures based on artist or genre.

Optionally, as shown in FIG. 7, based on the user's preferences described in the order.xml file, alternative delivery vehicles can be utilized in addition to, or in place of, the DVD disks. These alternative vehicles include, but are not limited to, hard drives, IPODs™, and other portable digital audio players.

The use of a pipelined system, with multi-threaded processes working in combination to convert the CD collection to digital audio files, creates significant advantages. Typically, the conversion of a single CD on a user's home computer to a set of MP3 files may take approximately fifteen to twenty minutes. If the user owned a collection of three hundred CDs, this process would consume 100 hours, or over one month if the user allocates 3 hours per day to this process. In contrast, the Digital Audio Recorder of the present invention is specially designed to optimize this particular operation. Therefore, in an optimized system, it is possible to convert a collection of 200 CDs to digital audio files in less than 2 hours. In addition to the significant increase in performance, the present invention also incorporates several deterrents to copyright infringement that typically would not be added if the user were to convert his own CD collection.

While the Digital Audio Recorder is optimized for transforming large collections, comprising in excess of one hundred CDs, into copyright protected digital files, its application is not so limited. Those skilled in the art will appreciate that multiple smaller orders can be aggregated to take advantage of the efficiencies inherent in the DAR. Thus, these efficiencies can be exploited even when the input collections are smaller than the optimized size. Similarly, those skilled in the art will appreciate that after the aggregated orders have been processed by the Digital Audio Recorder, they can be separated into their corresponding smaller orders before being burned onto DVDs. Thus, the design of the DAR allows for both the rapid and efficient transformation of large CD collections, as well as the rapid and efficient transformation of multiple smaller CD collections.

What is claimed:

1. A system for the high-speed replication of a compact disc (CD) collection to a corresponding set of digital audio files, comprising:
a first computing element adapted to convert the contents of each CD into a first set of digital files encoded in .wav format and a table of contents file;
second and third computing elements arranged so as to convert each of said first set of digital files into a format suitable for playback and to insert an identifying characteristic into each of said first set, thereby creating a second set of digital files;
a fourth computing element adapted to receive data specific to a CD from a database; and
a fifth computing element adapted to insert said data specific to said CD into each file of said second set of digital files associated with said CD to create a third set of digital files.

2. The system of claim 1, where said first computing element further comprises a compact disk autochanger.

3. The system of claim 1, where said first computing elements further comprises a robotic mechanism adapted to load said CD collection into said first computing element.

4. The system of claim 1, wherein said first computing element stores said first set of digital files in a location accessible by said second computing element, such that said second computing element begins conversion of said first set of digital files after the first of said first set is stored.

5. The system of claim 1, wherein said identifying characteristic is a digital watermark.

6. The system of claim 5, wherein said digital watermark is inserted using perceptual coding.

7. The system of claim 1, wherein said identifying characteristic contains information which identifies the owner of said CD.

8. The system of claim 1, wherein said suitable format is MP3.

9. The system of claim 1, wherein said suitable format is AAC.

10. The system of claim 1, wherein said suitable format is WMA.

11. The system of claim 1, wherein said fourth computing element further comprises means to communicate with a database accessible via the internet.

12. The system of claim 1, wherein said specific information comprises the title of said CD.

13. The system of claim 1, wherein said specific information comprises the title of the song on said CD.

14. The system of claim 1, wherein said specific information comprises the name of the performing artist on said CD.

15. The system of claim 1, wherein said second computing element stores a fourth set of digital files in a location accessible by said third computing element, such that said third computing element begins conversion of said fourth set of digital files after the first of said fourth set is stored.

16. The system of claim 1, wherein said third computing element stores said second set of digital files in a location accessible by said fifth computing element, and said fourth computing element stores said specific information in a location accessible by said fifth computing element, such that said fifth computing element begins conversion of said second set of digital files after said specific information and the first of said second set is stored.

17. The system of claim 1, wherein said second computing element to adapted to insert an identifying characteristic into each of said first set of digital files, thereby creating a fourth set of digital files and said third computing element is adapted to convert each of said fourth set of digital files into a format suitable for playback, thereby creating said second set.

18. The system of claim 1, wherein said second computing element to adapted to convert each of said first set of digital files into a fourth set suitable for playback and said third computing element is adapted to insert an identifying characteristic into each file of said fourth set, thereby creating said second set.

19. The system of claim 1, wherein said third set of digital files is written onto a DVD disk.

20. A method of replicating a CD collection to a set of digital audio files, comprising:
converting the contents of each CD of said collection into a first set of digital files in .wav format and a table of contents file;
encoding said first set of digital files into a format suitable for playback and inserting an identifying characteristic, thereby creating a second set of digital files;
using said table of contents file to access a database to obtain information specific to said CD; and
inserting said specific information into each file of said second set of digital files to create a third set of digital files.

21. The method of claim 20, whereby the owner of said CD collection initiates said method via a remote request.

22. The method of claim 21, whereby said remote request is the submission of a form via the internet.

23. The method of claim 20, whereby said third set of digital files is written onto at least one DVD disk.

24. The method of claim 20, wherein said identifying characteristic is a digital watermark.

25. The method of claim 24, wherein said digital watermark is inserted using perceptual coding.

26. The method of claim 20, wherein said identifying characteristic contains information which identifies the owner of said CD.

27. The method of claim 20, wherein said suitable format is MP3.

28. The method of claim 20, wherein said suitable format is AAC.

29. The method of claim 20, wherein said suitable format is WMA.

30. The method of claim 20, wherein said specific information comprises the title of said CD.

31. The method of claim 20, wherein said specific information comprises the title of the song on said CD.

32. The method of claim 20, wherein said specific information comprises the name of the performing artist on said CD.
